(19) United States
(12) Patent Application Publication
(10) Pub. No.: US 2015/0247998 A1
(43) Pub. Date: Sep. 3, 2015

(54) Device for Generating A Linear Intensity Distribution of a Laser Beam in a Working Plane

(71) Applicant: LIMO PATENTVERWALTUNG GMBH & CO. KG, Dortmund (DE)

(72) Inventor: Aleksei Mikhailov, Dortmund (DE)

(21) Appl. No.: 14/430,103

(22) PCT Filed: Sep. 24, 2013
(86) PCT No.: PCT/EP2013/069793

§ 371 Date: Mar. 20, 2015

(30) Foreign Application Priority Data
Sep. 24, 2012 (EP) 12185695.9

(51) Int. Cl. G02B 19/00; G02B 27/09

(52) U.S. Cl. CPC G02B 19/0023; G02B 19/0057; G02B 19/0028; G02B 27/0927

(57) ABSTRACT

A device for generating a linear intensity distribution (10) of a laser beam in a working plane (11) comprising at least one laser light source (2), optical means (3) which can form a plurality of sections (4) of the laser beam, and reflecting means on which the sections (4) of the laser beam formed by the optical means (3) can be reflected in such a manner that they are arranged adjacent to one another by the reflecting means in the working plane (11) in the longitudinal direction of the linear intensity distribution (10) to be produced and are combined into the linear intensity distribution (10). The reflecting means comprise particularly a plurality of mirror modules (5, 5′).

The present invention relates to a device for producing a linear intensity distribution of a laser beam in a working plane according to the preamble of claim 1.

Definitions: Laser beam, light beam, partial beam or beam does not, unless expressly stated otherwise, refer to an idealized beam in geometrical optics, but instead to a real light beam, such as a laser beam with a Gaussian profile or a modified Gaussian profile or a top-hat profile, which does not have an infinitesimally small beam cross-section, but an extended beam cross-section. Top-hat distribution or top-hat intensity distribution or top-hat profile refers to an intensity distribution that can be substantially described by a rectangular function (rect (x)) at least with respect to one direction. Real intensity distributions that deviate from a rectangular function in a percent range or have inclined flanks can herein also be described as a top-hat distribution or a top-hat profile.

A device of the aforementioned type is known from WO 2008/006460 A1. The device described therein includes laser modules arranged side-by-side, with each module having a laser light source and optical means. The optical means are designed such that the sections or sub-beams of the laser radiation emanating from the individual laser modules have a substantially linear beam cross-section, with the intensity dropping at the end-side edges of the line. This produces a trapezoidal profile in each of the sections or sub-beams. The trapezoidal profiles of the individual sub-beams or sections of the laser radiation are introduced next to each other into the working plane without the use of optical overlap means, so that the sections overlap in the region of the lateral flanks to a linear intensity distribution.

A disadvantage here is that the overlap regions may have a larger and/or smaller intensity than the plateau areas due to the shape of the flanks. Accordingly, the linear intensity distribution of the laser radiation may have undesirable inhomogeneities.

The problem underlying the present invention is to provide a device of the aforementioned type which can achieve a more homogeneous intensity distribution.

This is achieved by the invention with a device of the aforementioned type having the characterizing features of claim 1. The dependent claims relate to preferred embodiments of the invention.

According to claim 1, the device includes mirror means, at which the sections of the laser radiation shaped by the optical means can be reflected such that it they are then arranged by the mirror means side-by-side in the working plane in the longitudinal direction of the linear intensity distribution to be produced and combined into the linear intensity distribution. Joining the individual sections can be influenced specifically by the mirror means.

The mirror means may simultaneously operate as an aperture for the individual sections of the laser radiation, so that in the line longitudinal direction edge sections of the sections do not contribute to the linear intensity distribution in the longitudinal direction of the line.

In particular, when the individual sections have a trapezoidal profile or dropping edges in the edge regions of the line before the reflection at the mirror means, parts of a dropping edge or in particular the entire dropping edge can be cut off, with the result that only plateau-like profiles are consecutively arranged in the working plane. This can lead to a very good homogeneity of the intensity distribution in the working plane.

The mirror means may be constructed such that each of the sections of the laser radiation is reflected more than once. For example, the mirror means may be constructed such that each of the sections of the laser radiation is reflected three times. Due to the multiple reflections of the laser radiation at the mirror means, the sections to be interconnected can be brought into a desired arrangement.

The mirror means may include a plurality of mirror modules. By providing mirror modules, the length of linear intensity distribution to be produced can be increased by adding additional mirror modules and, if necessary, by adding additional laser modules.

One respective mirror module may be associated with each of the sections of the laser radiation. Alternatively, two respective mirror modules may be associated with each of the sections of the laser radiation. With both of these associations, the entire device can be scaled commensurate with the desired length of linear intensity distribution to be produced.

A plurality of reflecting surfaces may be formed on each of the mirror modules. The optional multiple reflections can then occur at a single mirror module.

The mirror means may include two differently designed groups of mirror modules, in particular groups having mirror symmetry. The variability of the device can be increased by using two groups of mutually different groups of mirror modules.

For example, in the longitudinal direction of linear intensity distribution to be produced, a first mirror module of a first of the two groups of mirror modules may be arranged adjacent to a first mirror module of the second of the two groups of mirror modules. In particular, the mirror modules of the two groups are arranged alternately side-by-side in the longitudinal direction of the linear intensity distribution to be produced. The footprint of the device can be reduced by arranging the different modules side-by-side.

Furthermore, mirror modules arranged side-by-side in the longitudinal direction of the linear intensity distribution to be produced may be offset from one another in the transverse direction of the linear intensity distribution to be produced. This measure can also reduce the footprint of the device.

The mirror modules may be constructed and arranged in the device such that a section, preferably each section, of the laser radiation is first reflected at least once at a mirror module of the first of the two groups of mirror modules and thereafter reflected at a mirror module of the second of the two groups of mirror modules. Such a design exploits the cooperation of the mirror modules, thus increasing the overall effectiveness of the device.

The device may furthermore include focusing means capable of focusing the laser light emanating from the mirror modules into the working plane. In this way, a desired line width can be obtained in the transverse direction of the line to be produced.

The focusing means may include a focusing lens, in particular a focusing lens having segments arranged side-by-side in the longitudinal direction of line, preferably segments that are or can be interconnected. The design of the focusing lens using individual segments supports the modular construction of the device, so that scaling to the desired line length can also be accomplished with respect to the focusing means.

The mirror means may be constructed such that the cross-section of at least one section, preferably of each of the sections, of the laser beam is rotated by the mirror means by 90°. In this way, the device can be made more compact and the individual sections can be joined close to each other.

Additional features and advantages of the present invention will become apparent from the following description of preferred exemplary embodiments with reference to the accompanying drawings, wherein:

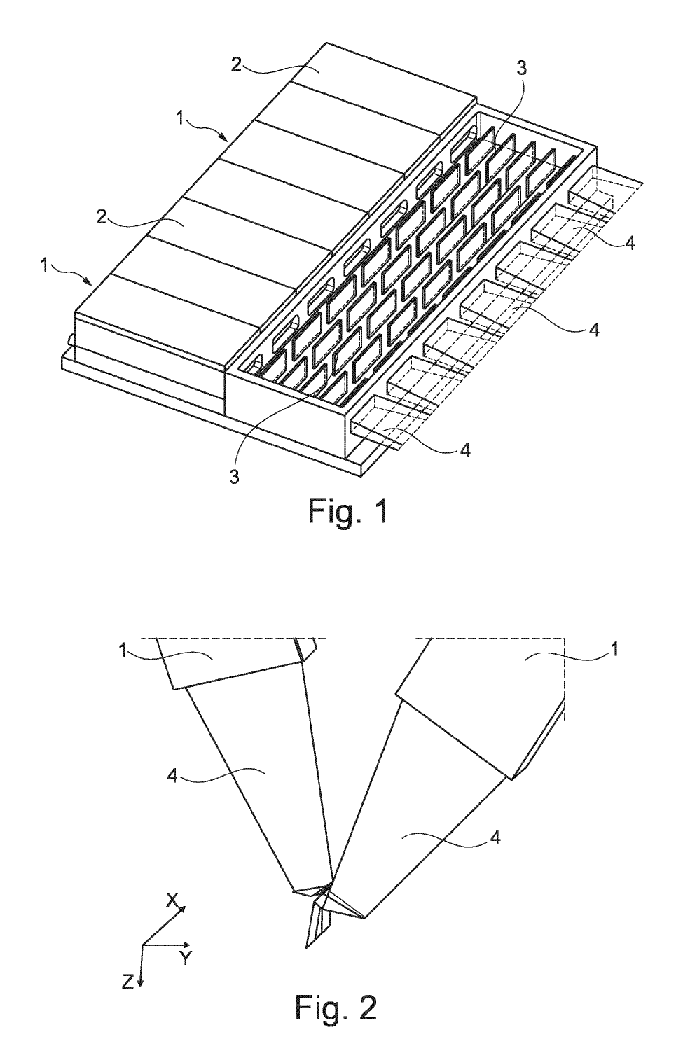

FIG. 1 is a perspective view of a plurality of laser light sources and optical means, which may be part of a device according to the invention;

FIG. 2 is a partial perspective view of a device according to the invention and the laser radiation generated by this device, wherein the mirror modules are not shown;

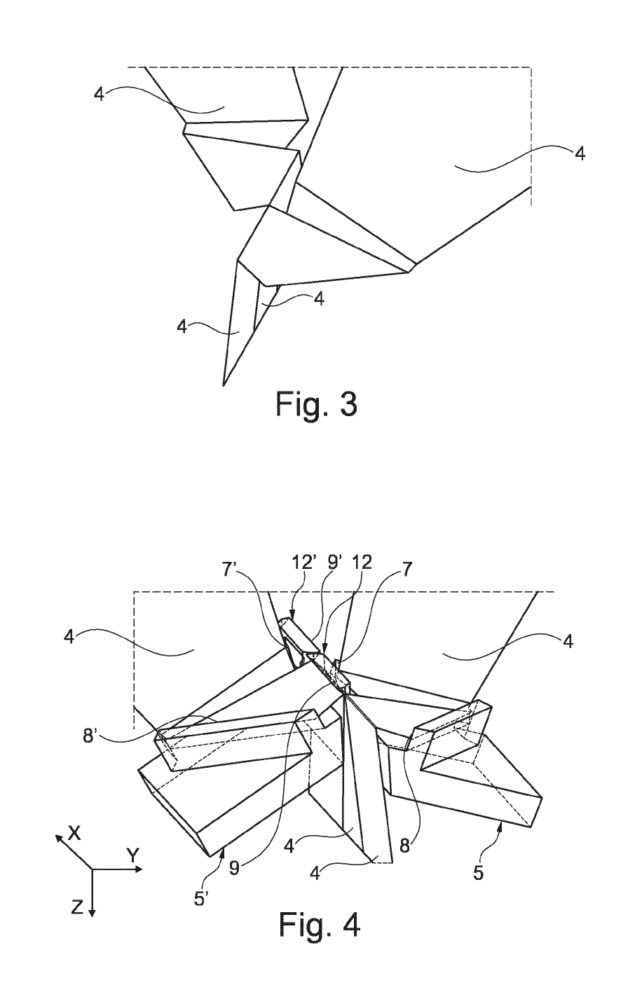

FIG. 3 shows an enlarged detail view of FIG. 2;

FIG. 4 is a view corresponding substantially to FIG. 3 with mirror modules;

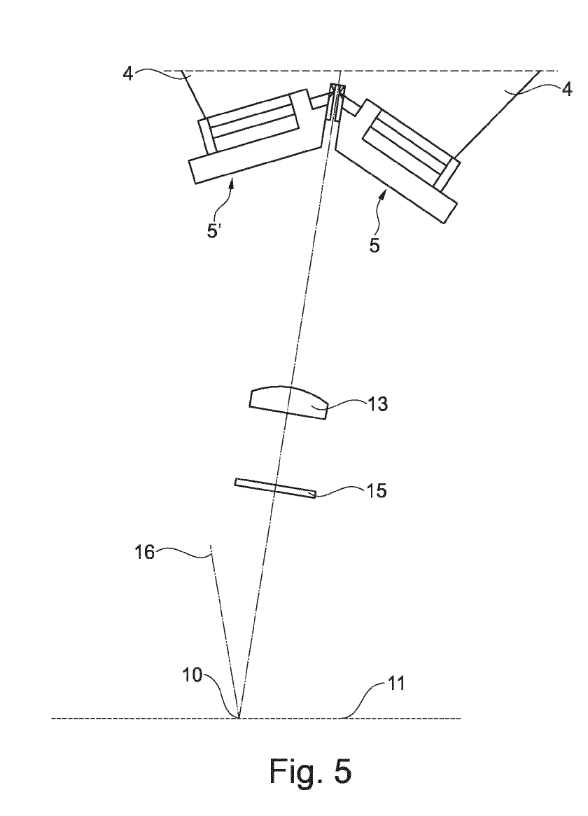

FIG. 5 is a side view of part of a device according to the invention with focusing means and a housing window;

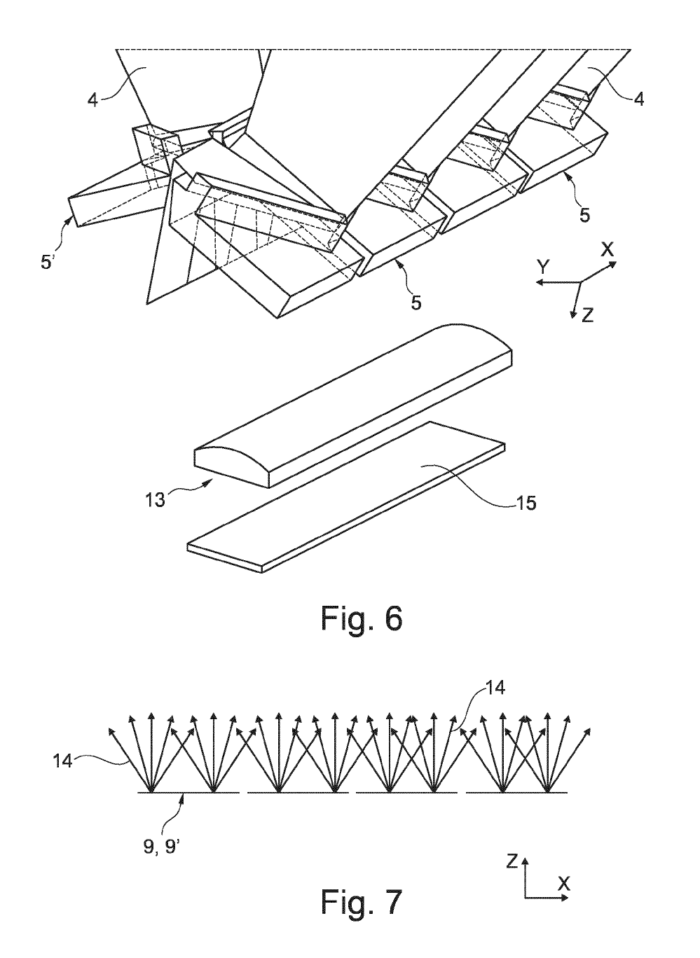

FIG. 6 is a partial perspective view of the device of FIG. 5;

FIG. 7 is a schematic diagram of the laser radiation emanating from the mirror modules.

In the figures, identical or functionally identical parts are provided with the same reference symbols. Cartesian coordinate systems are shown in some of the figures to facilitate orientation.

A device according to the invention includes at least one laser light source constructed, for example, as a laser diode or a laser diode bar. FIG. 1 shows an example of a plurality of laser modules 1 taken from WO 2008/006460 A1, which are each provided with laser light sources 2 and optical means 3. WO 2008/006460 A1 is hereby incorporated by reference as a part of the present application.

In the exemplary embodiment illustrated in FIG. 1 of WO 2008/006460 A1 seven laser light sources 2 and seven optical means 3 associated with these laser light sources 2 are shown, with each generating a section 4 of laser radiation with an at least partially linear intensity distribution. However, more or fewer laser light sources 2 and optical means 3 may be provided.

Each of the laser light sources 2 forms together with the corresponding optical means a laser module 1 which can be exchanged separately. Furthermore, the length of the linear intensity distribution to be produced can be increased by increasing the number of laser modules 1.

The optical means 3 can include, for example, homogenizers in accordance with WO 2008/006460 A1. which adjust the line length and the flank shape of each individual section 4 of the laser radiation so as to produce a linear intensity distribution in the working plane through superposition of the individual lines of the sections. The composite seven sections 4 or sub-beams of the laser radiation provide a homogeneous linear intensity distribution in a working plane.

The employed homogenizer in accordance with WO 2008/006460 A1 can each have a plurality of cylindrical lenses in the form of a lens array. For example, the center distances (pitch) of the cylindrical lenses in the center of the lens array may be smaller than at the edge. This is achieved by increasing the width of the cylindrical lenses from the center towards the outside in the direction in which they are arranged side-by-side. Alternatively, the center distance may decrease from the center towards the outside. However, the focal length of the cylindrical lenses may still be the same for all the cylindrical lenses.

This configuration of the optical means produces an intensity distribution of the individual sections 4 of the laser radiation with an extended plateau at the center and a sharp drop at the edge. Accordingly, a more or less elongated trapezoidal profile is produced.

In the context of the present application, a device is described wherein similar laser modules 1 composed of laser light sources 2 and optical means 3 are provided in a different arrangement. In particular, the lines of the sections 4 of the laser radiation emanating from the laser modules 1 are arranged approximately perpendicular to the direction in which the sections 4 are arranged side-by-side.

FIG. 2 and FIG. 6 show that the individual sections 4 propagate approximately in the Z-direction, They have in the transverse direction, which corresponds approximately to the Y-direction, a linear intensity distribution, but are arranged side-by-side in the X-direction or in FIG. 2 and FIG. 6 one behind the other. Respective adjacent sections 4 are arranged with a mutual offset in the transverse direction of the line or in the Y-direction.

Two schematically depicted parts of the laser modules 1 are visible at the top of FIG. 2. These are arranged so that the sections 4 of the laser radiation are each slightly tilted with respect to the Z-direction.

In the illustrated exemplary embodiment of a device according to the invention, each of the sections 4 of the laser radiation undergoes three reflections. For this purpose, the device includes mirror means, which are formed on mirror modules 5, 5′. The individual mirror modules 5, 5′ are in particular integral or monolithic components. Two different groups of mirror modules 5, 5′ are provided.

The first group includes mirror modules 5 of a first type, which are arranged on the right hand side of FIG. 4. The second group includes mirror modules 5′ of a second type, which are arranged on the left hand side of FIG. 4. The two types of mirror modules 5, 5′ have different handedness. They are mirror-symmetrical to each other relative to an X-Z-plane (see FIG. 4).

Each of the mirror modules 5, 5′ has three reflecting surfaces 7, 7′, 8, 8′, 9, 9′. The sections 4 which essentially propagate in the Z-direction are reflected at the first reflecting surfaces 7, 7′ so that they then propagate in the negative X-direction (see FIG. 4). The sections 4 of the laser radiation are reflected at the second reflecting surfaces 8, 8′ so that they then propagate essentially in the negative or the positive Y-direction. The sections 4 of the laser radiation are thereafter reflected at the third reflecting surfaces 9, 9′ downward in FIG. 4 in the Z-direction.

After the three-fold reflections, the individual sections 4 of the laser radiation still propagate approximately in the same Z-direction, but are rotated with respect to their cross-section by 90°. Before the reflections, the longitudinal directions of the linear cross-sections of the sections 4 extend approximately in the Y-direction. After the reflections, the longitudinal directions of the linear cross-sections of sections 4 extend in the X-direction (see FIG. 3). In this way, the linear cross-sections of the adjacent sections 4 of the laser radiation abut each other after the three reflections, thus forming a continuous linear intensity distribution 10 in a working plane 11 (see FIG. 4 and FIG. 5).

The mirror modules 5, 5′ include projections 12, 12′ having the third reflecting surfaces 9, 9′ disposed on their outer side. These projections 12, 12′ abut each other in the X-direction. In particular, the projections 12, 12′ and hence the third reflecting surfaces 9, 9′ have slightly smaller dimensions in the X-direction than the linear cross sections of the incident sections 4 of the laser radiation. The reflective surfaces 9, 9′ thus act simultaneously as an aperture truncating the edges of the intensity distribution of the sections 4. In particular, when the individual sections 4 have a trapezoidal profile, truncation of the edges ensures that intensity distributions with an almost complete top-hat profile abut each other in the working plane 11 and produce in combination a homogeneous linear intensity distribution 10.

In the illustrated exemplary embodiment of the device, a mirror module 5 of the first group and a mirror module 5′ of the second group are alternately arranged in the X-direction (see FIG. 6). The illustrated exemplary embodiment further shows that the sections 4 of the laser radiation emanating from a reflecting surface 8′ of a mirror module 5′ of the second kind are subsequently reflected by a reflecting surface 9 of a mirror module 5 of the first, kind downward in Z-direction, and vice versa (see FIG. 4).

FIG. 5 and FIG. 6 show schematically that the device includes focusing means 13 which are arranged below the mirror modules 5, 5 in the Z-direction and are formed, for example, as a single cylindrical lens or a plurality of cylindrical lens segments abutting in the X-direction. Even when the focusing means 13 are composed of several cylindrical lens segments in the X-direction, this does not adversely affect the homogeneity in longitudinal direction (X-direction) of the line, because, as shown schematically in FIG. 7, the sections 4 of the laser radiation reflected at the third reflecting surfaces 9, 9′ have a certain divergence, as indicated by the exaggerated depiction of the sub-beams 14.

FIG. 5 and FIG. 6 furthermore show a window 15 of a housing which may surround the device. FIG. 5 also shows the laser radiation 16 optionally reflected by the working plane, which may be guided, when appropriate and depending on the application, into an unillustrated beam trap.

1. A device for producing a linear intensity distribution (10) of a laser beam in a working plane (11), comprising
at least one laser light source (2),
optical arrangements (3) capable of forming a plurality of sections (4) of the laser radiation,
mirror arrangements, at which the plurality of sections (4) of the laser radiation shaped by the optical means (3) is reflected so as to be arranged by the mirror arrangement side-by-side in the working plane (11) in longitudinal direction of the linear intensity distribution (10) to be produced and to be combined into the linear intensity distribution (10).

2. The device according to claim 1, wherein the mirror means operate at the same time as an aperture for the individual sections (4) of the laser radiation, so that edge regions of the sections (4) do not contribute to the linear intensity distribution (10) in the longitudinal direction line of the line.

3. The device according to claim 1, wherein the mirror arrangements are designed so as to reflect each of the sections (4) of the laser radiation more than once.

4. The device according to claim 3, wherein the mirror arrangements are designed so as to reflect each of the sections (4) of the laser radiation three times.

5. The device according to claim 1, wherein the mirror means comprises a plurality of mirror modules (5, 5′).

6. The device according to claim 5, wherein a respective one of the mirror modules (5, 5′) is assigned to each of the sections (4) of the laser radiation.

7. The device according to claim 5, wherein two of the mirror modules (5, 5′) are assigned to each of the sections (4) of the laser radiation.

8. The device according to claim 5, wherein a plurality of reflective surfaces (7, 7′, 8, 8′, 9, 9′) is formed on each of the mirror modules (5, 5′).

9. The device according to claim 1, wherein the mirror arrangements comprise two groups of mirror modules (5, 5′) which are designed differently.

10. The device according to claim 9, wherein in longitudinal direction of the linear intensity distribution (10) to be produced, a first mirror module (5) of a first of the two groups of mirror modules (5, 5′) is arranged adjacent to a first mirror module (5′) of the second the two groups of mirror modules (5, 5′).

11. The device according to claim 9 wherein in the longitudinal direction of the linear intensity distribution (10) to be produced, the mirror modules (5, 5′) of the two groups are arranged alternately side-by-side.

12. The device according to claim 9, wherein in the longitudinal direction of the linear intensity distribution (10) to be produced, mirror modules (5, 5′) arranged side-by-side are arranged with an offset from one another in the transverse direction of the linear intensity distribution (10) to be produced.

13. The device according to claim 9, wherein the mirror modules (5, 5′) are constructed and arranged in the device such that at least one section (4), of the laser radiation is reflected first at least once at a mirror module (5) of the first of the two groups of mirror modules (5, 5′) and is thereafter reflected at a mirror module (5′) of the second of the two groups of mirror modules (5, 5′).

14. The device according to claim 1 further comprises focusing arrangement (13) capable of focusing the laser light emanating from the mirror modules (5, 5′) into the working plane (11).

15. The device according to claim 14, wherein the focusing arrangement (13) comprise a focusing lens having segments arranged side-by-side.

16. The device according to claim 1, wherein the mirror arrangements are constructed such that the cross section of at least one section (4), of the laser radiation is rotated by the mirror means by 90°.

17. The device according to claim 9, wherein the two groups of mirror modules (5, 5′) are designed with mutual mirror symmetry.

18. The device according to claim 14, wherein the focusing lens has in the longitudinal direction of the line, segments arranged side-by-side, and which segments are interconnected or interconnectable.

19. The device according to claim 16, wherein the cross section of each of the sections (4) of the laser radiation is rotated by the mirror means by 90°.
